(19) United States
(12) Patent Application Publication
(10) Pub. No.: US 2009/0309838 A1
(43) Pub. Date: Dec. 17, 2009

(54) USE OF SEPARATION ELEMENTS WITH REAR PROJECTION SCREEN

(75) Inventors: Manolito Adan, Woodinville, WA (US); Bernard Schultz, Edmonds, WA (US); Prafulla Masalkar, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/137,518

(22) Filed: Jun. 11, 2008

(51) Int. Cl. G06F 3/041; G01J 5/00; H01J 9/00

(52) U.S. Cl. 345/173; 250/338.1; 445/24

(57) ABSTRACT

A rear projection display devices includes a diffusion layer having an interface surface configured to diffuse visible light, and a visible light projection subsystem configured to project a display image at the interface surface using the visible light to be diffused by the diffusion layer. The rear projection display devices may also include a light transmissive base configured to provide a support for the interface surface, and an infrared touch-sensing subsystem including an infrared light source configured to project infrared light at the base, and an infrared light detector configured to detect infrared light reflecting from the interface surface. Separation elements may be disposed between the diffusion layer and the base so as to maintain a separation between the diffusion layer and the base.

### BACKGROUND

A surface computer may include an interface surface on which a graphical user interface image may be projected. A diffuser layer may be used to diffuse the projected image, and may rest upon a base layer. There may be an air gap between the base layer and the diffuser layer. When a user makes contact with the interface surface the air gap between the diffuser layer and the base layer may become uneven, and wherever the two materials touch, Newton rings may be temporarily formed and/or a “wetting” effect may be observed. A wetting effect, and the Newton rings, are undesirable in that they may adversely affect the visual display, and/or the user experience.

### SUMMARY

The use of separation elements with rear projection screens is disclosed. Rear projection display devices may include a diffusion layer having an interface surface configured to diffuse visible light, and a visible light projection subsystem configured to project a display image at the interface surface using the visible light to be diffused by the diffusion layer. The rear projection display devices may also include a light transmissive base configured to provide a support for the interface surface, and an infrared touch-sensing subsystem including an infrared light source configured to project infrared light at the base, and an infrared light detector configured to detect infrared light reflecting from the interface surface. Separation elements may be disposed between the diffusion layer and the base that may be configured to maintain a separation between the diffusion layer and the base.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A schematically shows a rear projection display device in accordance with an embodiment of this disclosure.

FIG. 1B schematically shows a screen assembly of the rear projection display device of FIG. 1A in more detail.

FIG. 2 is a cross-sectional view taken at the line 2-2 in FIG. 1B.

FIG. 3 is a cross-sectional view taken at the line 3-3 in FIG. 2.

FIGS. 4-9 are flowcharts illustrating various embodiments of a method for reducing Newton rings and wetting effects.

### DETAILED DESCRIPTION

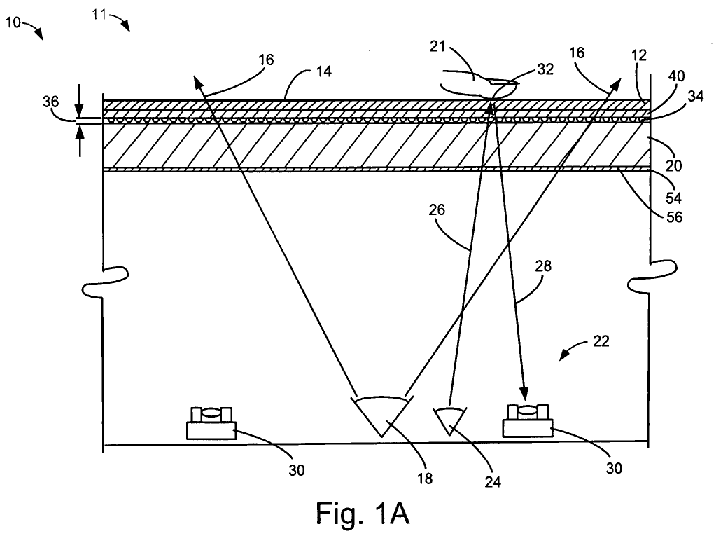

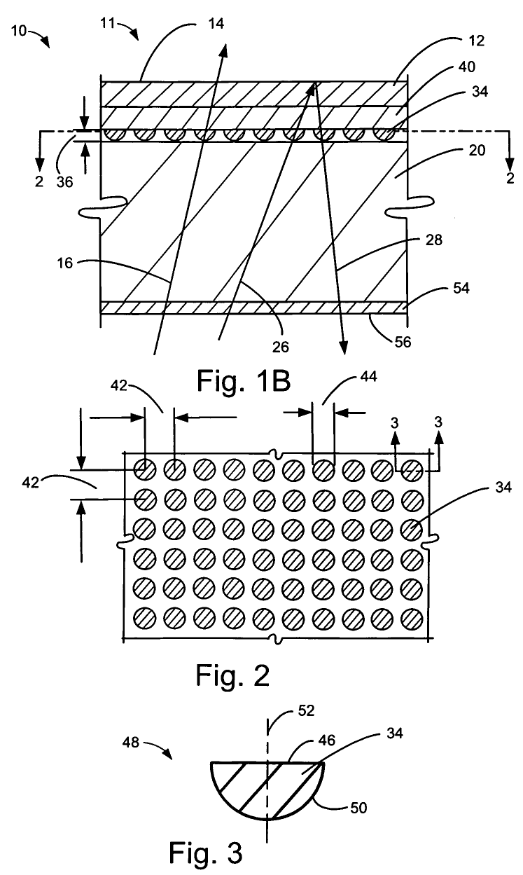

FIG. 1A illustrates a schematic cross-sectional view of a surface computer 10, and FIG. 1B shows a screen assembly of the surface computer 10 in more detail. FIG. 1A and FIG. 1B also illustrate a rear projection screen 11 that may be included as part of a surface computer 10, or another interactive device such as a game, or a consumer interactive system, or the like.

The surface computer 10 may include a diffusion layer 12 that may include an interface surface 14 that may be configured to allow one or more users to interface with the surface computer 10. The diffusion layer 12 may be configured to diffuse visible light 16 that may be projected from a visible light projection subsystem 18. The visible light projection subsystem 18 may be configured to project a display image at the interface surface 14 using the visible light 16. The display image may be diffused by the diffusion layer 12 such that it may be easier for the one or more users to see.

The display image may include, for example, a graphical user interface that may include graphical objects that may prompt interaction with the one or more users, or that may graphically represent the results of user manipulation of the graphical objects. A user may, for example, retrieve digital photographs from a digital memory for viewing, and/or manipulation. As another example, a user may communicate a request, such as ordering a meal from a menu displayed on the interface surface 14 at a restaurant. The surface computer 10 may be strong enough to support a substantial amount of weight, such as the one or more users leaning on it, or using the interface surface 14 as a tabletop surface for a meal, or a beverage, or the like. A light transmissive base 20 may be configured to provide a support for the interface surface 14. The base 20 may be sufficiently strong to span a surface area that may be big enough to serve as a dining table, or a work surface, or virtually any other desired size. The base 20 may be disposed substantially horizontally and configured to provide a support for the interface surface and configured to support a weight exerted on it via the diffusion layer. The weight may be for example more that 5 pounds. The base 20 may be made from a clear acrylic, or the like. The base 20 may have a thickness that may be, for example, from 5 to 20 mm thick, although other thicknesses are also in the scope of this disclosure. For example the base 20 may be approximately 12 mm thick.

The diffusion layer 12 may also be made from an acrylic material, and may be sufficiently thin to reduce total internal reflection effects. For example the diffusion layer 12 may be less than 1 mm thick.

The surface computer 10 may be configured such that a user may interact with it by touching the interface surface 14 with one or more physical objects 21. The physical objects 21 may be used as input devices, and may include fingers, or hands. The surface computer 10 may include an infrared touch-sensing subsystem 22 that may include an infrared light source 24 that may be configured to project infrared light 26 through the base 20 and at the interface surface 14. A portion of the infrared light 26 may be reflected off the interface surface 14 as reflected infrared light 28, and an infrared light detector 30 may be configured to detect the reflected infrared light 28. The surface computer 10 may include more than one infrared light detector 30 to detect the reflections of one of more objects 21, and to accurately register the location of the objects on the interface surface 14. For example, three or more infrared light detectors 30 may be used. In one embodiment, five infrared light detectors 30 may be used. Other numbers of infrared light detectors 30 are also within the scope of this disclosure.

The infrared light may have a wavelength between 800 and 900 nanometers, although other wavelengths are also within the scope of this disclosure. In various embodiments the infrared light 26 may have a wavelength substantially equal to 850 nanometers.

The surface computer 10 may also include separation elements 34 that may be disposed between the diffusion layer 14 and the base 20. The separation elements 34 may be configured to maintain a separation 36, or air gap, between the diffusion layer 14, and the base 20, or a stiffener layer 40 (discussed below), and the base. The separation 36 may be a substantially consistent distance. In various embodiments a distance between the diffusion layer 14, and the base 20 may be greater than seven micrometers, and in some cases at least eight micrometers. By maintaining a consistent distance, or a uniform air gap, the appearance of Newton Rings, and/or a wetting effect, on the interface surface may be reduced or even or eliminated.

Each separation element 34 may be substantially transparent to the incident infrared light 26, and to the reflected infrared light 28, and to the visible light 16. Substantially transparent to visible light 16 may be, for example, not detectable to the naked eye by a typical user. Substantially transparent to the infrared light 26, and the reflected infrared light 28, may be considered to be achieved if, for example, the infrared light detectors 30 can detect the location of the object 21 to be within a predetermined placement tolerance of the actual point of contact 32 without un-resolvable interference from a separation element 34. In some embodiments the separation elements 34 may have an index of refraction such that the separation elements 34 may be able to transmit up to 85% of light in the infrared range. This may reduce any reflection back to the infrared light source 24.

In various embodiments the separation elements 34 may have various predefined optical properties. For example the index of refraction may be within a range of 1.3 to 1.7, and may be for example, 1.5. The transmittance may be within a range of, for example, 90% to 98% and may be, for example, greater than 92%. The reflectance may be within a range of, for example, 2% to 6%, and may be, for example, less than 5%. The absorption in the visible range may be, for example, in a range of 0.02% to 0.06%, and may be, for example, less than 0.05%. The absorption in the 850-870 nm range may be, for example, in a range of 0.02% to 0.06%, and may be, for example, less than 0.05%.

The surface computer 10 may include the stiffener layer 40 adjacent to the diffusion layer 12. The stiffener layer 40 may be attached to the diffusion layer 12 with, for example, an adhesive. The separation elements 34 may be formed on the stiffener layer 40 when the stiffener layer 40 is included. In embodiments without a stiffener layer 40 the separation elements 34 may be formed on the diffusion layer. In embodiments with or without the stiffener layer 40 the separation elements 34 may be formed on the base 20.

FIG. 2 is a cross-sectional view taken at the line 2-2 in FIG. 1B illustrating a number of the separation elements 34. As illustrated, in some embodiments the separation elements 34 may be circular in shape. The separation elements 34 may be arranged in a pattern having a pitch 42 of approximately 3 mm by 3 mm. In some embodiments the separation elements 34 may have a separation element width 44 that is less than a width of a pixel of the display image. In other embodiments, the separation elements 34 may be differently sized and/or differently spaced and/or patterned.

In various embodiments the separation elements 34 may have a diameter of, for example, 200-250 micrometers. The separation elements 34 may be, for example, 10-15 micrometers in height. Other diameters and heights are also in the scope of this disclosure. FIG. 3 is a cross-sectional view taken at the line 3-3 in FIG. 2 illustrating one separation element 34. Each of the separation elements 34 may include a substantially flat surface 46 that may be configured to be disposed substantially parallel with the interface surface 14. Each of the separation elements 34 may also have a substantially convex shape 48 having a convex outer surface 50, and a central axis 52. The separation elements 34 may then be oriented with the central axis 52 oriented substantially normal to the interface surface 14, and wherein the concave outer surface 50 faces toward or away from the base 20. In other embodiments, the separation elements 34 may be differently shaped.

In various embodiments the separation elements 34 may be emulsion applied separation elements 34 on the stiffener 40, the diffusion layer 12, or the base 20. In various embodiments the separation elements 34 may be printed on the stiffener 40, the diffusion layer 12, or the base 20 using a printing operation. For example, the separation elements may be silkscreen applied separation elements 34. A stainless steel or nylon silkscreen mesh may be utilized in some embodiments.

In various embodiments the separation elements 34 may be configured to meet various measures of durability. Material characteristics of the separation elements 34 may have a modulus of elasticity of, for example, 3300 to 4000 MPascals. In some embodiments, the separation elements 34 may be configured to withstand a single point load of 9 kg distributed from a 0.28 cm² blunt surface. When subject to such a load the separation elements 34 may, for example, deflect an amount which may be less than, or approximately equal to 5 micrometers. As another example of a durability test for the separation elements 34, after 1,000 cycles, of being subjected to the point load described, or similar, the maximum permanent deformation may not exceed 10%.

Other measures of durability of the separation elements 34 may include configuring the separation elements 34 to be able to withstand a load of, for example, 91 kg distributed over 100 cm² without any permanent deformation or polymer breakdown. The separation elements 34 may be configured to maintain elastic properties without becoming too brittle over a predetermined length of time.

Various embodiments may use, for example, an ASTM D 5420 Gardner Impact Tester. As an example test sample, a 5 cm×5 cm sample may be used and subjected to the following procedures. Following the test, the dots must not permanently deform by more than 15%. The sample may include a stack-up of layers including a diffuser assembly including a diffuser layer 12, stiffener layer 40 and separation elements 34 which may be extruded 12 mm. Then a striker having, for example, a 3 mm radius ball surface may be set to rest on the diffuser side. Then to simulate a large shock load, a minimal dropping height may be selected which may be incrementally increased to a height to just below the point where the acrylic fails. Then before and after impact separation elements 34 may be compared in a scanning electron microscope. Loads of, for example, 1.8 kg and 0.9 kg may be used for comparison. As an example, the impact test may be repeated 10 times, on the same sample on the same spot.

In various embodiments the separation elements 34 may be formed using, for example, epoxy based paint. In some embodiments micronized glass bead filled epoxy paint may be used that may include microsphere sizes of, for example, 15 to 30 microns. The glass bead material may be borosilicate.

Returning to FIGS. 1A and 1B, an antireflective film 54 may be adjacent to a bottom surface 56 of the base 20, and may be attached to the bottom surface 56 with, for example, an adhesive. The antireflective film 54 may reduce reflection of one or both of the visible light 16 and the infrared light 26 from the bottom surface of the base 20, and may allow for efficient transmission of the visible light 16 and the infrared light 26 through the base 20.

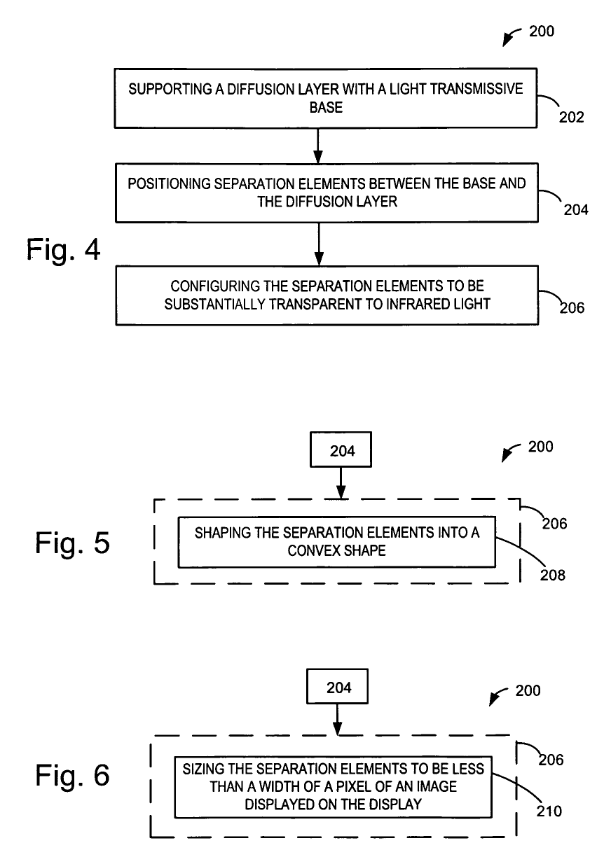

FIG. 4 is a flow chart illustrating a method 200 of constructing a touch sensitive display having an infrared touch sensing subsystem. The method 200 may include, at 202, supporting a diffusion layer with a light transmissive base. The method 200 may also include, at 204, positioning separation elements between the base and the diffusion layer. The method 200 may also include, at 204, configuring the separation elements to be substantially transparent to infrared light.

FIGS. 5 and 6 are flow charts illustrating variations of the method 200. As shown in FIG. 5, the configuring the separation elements 206 may optionally include, at 208, shaping the separation elements into a convex shape. As shown in FIG. 6, the configuring the separation elements 206 may optionally include, at 210, sizing the separation elements to be less than a width of a pixel of an image displayed on the display.

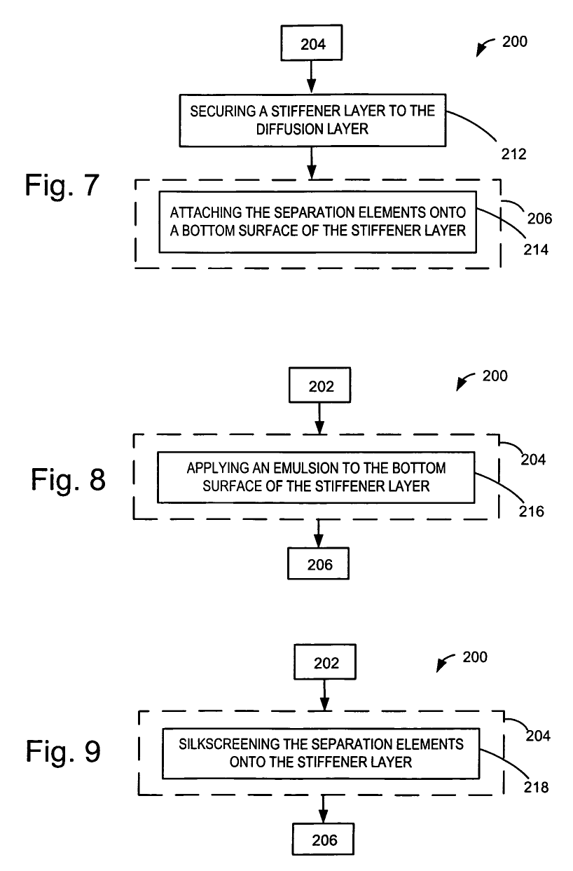

FIG. 7 is a flow chart illustrating another variation of the method 200. The method 200 may optionally include, at 212, securing a stiffener layer to the diffusion layer. In this option, the configuring the separation elements 206 may include, at 214, attaching the separation elements onto a bottom surface of the stiffener layer.

FIG. 8 is a flow chart illustrating another variation of the method 200. In this option, the positioning the separation elements 204 may include, at 216, applying an emulsion to the bottom surface of the stiffener layer. Alternatively, the method 200 may include applying an emulsion to a surface of the diffusion layer.

FIG. 9 is a flow chart illustrating yet another variation of the method 200. In this option, the positioning the separation elements 204 may include, at 218, silk-screening the separation elements onto the stiffener layer.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

1. A surface computer, comprising:
a diffusion layer including an interface surface configured to diffuse visible light;
a visible light projection subsystem configured to project a display image at the interface surface using the visible light to be diffused by the diffusion layer;
a light transmissive base configured to provide a support for the interface surface;
an infrared touch-sensing subsystem including an infrared light source configured to project infrared light at the interface surface, and an infrared light detector configured to detect infrared light reflecting from the interface surface; and
separation elements disposed between the diffusion layer and the base and configured to maintain a separation between the diffusion layer and the base.

2. The surface computer of claim 1, wherein each separation element is substantially transparent to the infrared light and the visible light.

3. The surface computer of claim 1, wherein each separation element includes a substantially flat surface disposed substantially parallel with the interface surface and a convex outer surface opposite the substantially flat surface.

4. The surface computer of claim 3, wherein the convex outer surface faces the base.

5. The surface computer of claim 1, wherein each separation element is configured to maintain a substantially consistent distance between the diffusion layer and the base.

6. The surface computer of claim 1, further comprising a stiffener layer adjacent to the diffusion layer, and wherein the separation elements are formed on the stiffener layer.

7. The surface computer of claim 1, wherein the separation elements are formed on the diffusion layer.

8. The surface computer of claim 1, wherein the separation elements are formed on the base.

9. The surface computer of claim 1, wherein the separation elements are arranged in a pattern having a pitch of approximately 3 mm by 3 mm.

10. The surface computer of claim 1, wherein at least some of the separation elements have a separation element width that is less than a width of a pixel of the display image.

11. The surface computer of claim 6, wherein the separation elements are emulsion applied separation elements on the stiffener layer.

12. The surface computer of claim 6, wherein the separation elements are silkscreen applied separation elements on the stiffener layer.

13. A method of constructing a touch sensitive display having an infrared touch sensing subsystem, the method comprising:
supporting a diffusion layer with a light transmissive base;
positioning separation elements between the base and the diffusion layer; and
configuring the separation elements to be substantially transparent to infrared light.

14. The method of claim 13, wherein the configuring the separation elements includes shaping the separation elements into a convex shape.

15. The method of claim 13, wherein the configuring the separation elements includes sizing the separation elements to be less than a width of a pixel of an image displayed on the display.

16. The method of claim 13, further comprising securing a stiffener layer to the diffusion layer, and wherein the configuring the separation elements includes attaching the separation elements onto a bottom surface of the stiffener layer.

17. The method of claim 16, wherein the positioning the separation elements includes applying an emulsion to the bottom surface of the stiffener layer.

18. The method of claim 15, wherein the positioning the separation elements includes silk-screening the separation elements onto the stiffener layer.

19. A surface computer, comprising:
a substantially horizontally orientated diffusion layer including an interface surface configured to diffuse visible light;
a visible light projection subsystem configured to project a display image at the interface surface using the visible light to be diffused by the diffusion layer;
a substantially horizontally orientated light transmissive base configured to support the diffusion layer;
an infrared touch-sensing subsystem including an infrared light source configured to project infrared light at the interface surface, and an infrared light detector configured to detect infrared light reflecting from the interface surface; and
separation elements disposed between the diffusion layer and the base and configured to maintain a separation between the diffusion layer and the base.

20. The surface computer of claim 19, wherein each of the separation elements have a convex shape and a central axis, and wherein the separation elements are oriented with the central axis oriented substantially normal to the interface surface.
